(19) United States
(12) Patent Application Publication
(10) Pub. No.: US 2026/0261325 A1
(43) Pub. Date: Sep. 3, 2026

(54) METHOD AND APPARATUS FOR PERFORMING SEMANTIC COMMUNICATION IN WIRELESS COMMUNICATION SYSTEM

(71) Applicant: LG ELECTRONICS INC., Seoul (KR)

(72) Inventors: Ikjoo JUNG, Seoul (KR); Sangrim LEE, Seoul (KR); Soonhee KWON, Seoul (KR); Taehyun LEE, Seoul (KR)

(21) Appl. No.: 19/491,223

(22) PCT Filed: Jun. 14, 2023
(86) PCT No.: PCT/KR2023/008221

§ 371 Date: Dec. 8, 2025

(51) Int. Cl. H04B 7/08; H04L 41/16; H04W 48/16

(52) U.S. Cl. CPC H04B 7/0848; H04L 41/16; H04W 48/16

(57) ABSTRACT

The present disclosure relates to a method by which a first node operates in a wireless communication system, and the method may comprise the steps of: establishing a connection with a second node; receiving a first node capability information request from the second node; transmitting first node capability information to the second node on the basis of the first node capability information request; receiving semantic communication instruction information from the second node; performing semantic communication learning on the basis of the received semantic communication instruction information so as to train at least one model; receiving target AI task information from the second node; and encoding input data on the basis of a JSCC encoder model, which corresponds to the target AI task information, and transmitting same to the second node.

### CROSS-REFERENCE TO RELATED APPLICATIONS

This application is the National Stage filing under 35 U.S.C. 371 of International Application No. PCT/KR2023/008221 filed on Jun. 14, 2023, which is all hereby incorporated by reference herein in their entirety.

### TECHNICAL FIELD

The following description relates to a method and a device for performing semantic communication in a wireless communication system. Specifically, the following description relates to a method and a device for performing semantic communication in consideration of multi-task operation in a wireless communication system.

### BACKGROUND

Radio access systems have come into widespread in order to provide various types of communication services such as voice or data. In general, a radio access system is a multiple access system capable of supporting communication with multiple users by sharing available system resources (bandwidth, transmit power, etc.). Examples of the multiple access system include a code division multiple access (CDMA) system, a frequency division multiple access (FDMA) system, a time division multiple access (TDMA) system, a single carrier-frequency division multiple access (SC-FDMA) system, etc.

In particular, as many communication apparatuses require a large communication capacity, an enhanced mobile broadband (eMBB) communication technology has been proposed compared to radio access technology (RAT). In addition, not only massive machine type communications (MTC) for providing various services anytime anywhere by connecting a plurality of apparatuses and things but also communication systems considering services/user equipments (UEs) sensitive to reliability and latency have been proposed. To this end, various technical configurations have been proposed.

### SUMMARY

The present disclosure relates to a method and a device for performing semantic communication in a wireless communication system.

The present disclosure relates to an operation method and a device based on multiple artificial intelligence (AI) task operation, which is performed based on semantic communication in a wireless communication system.

The present disclosure relates to a method and a device for performing learning based on combinations of AI tasks, which is performed based on semantic communication in a wireless communication system.

The present disclosure relates to a method and a device for performing multiple AI task-based communication based on a learning model corresponding to a configured target AI task, which is performed based on semantic communication in a wireless communication system.

The technical objects to be achieved by the present disclosure are not limited to the matters mentioned above, and other technical problems not mentioned may be considered by those skilled in the art to which the technical configuration of the present disclosure is applied, from embodiments of the present disclosure to be described below.

According to an embodiment of the present disclosure, a method performed by a first node in a wireless communication system, the method may include: establishing a connection with a second node, receiving, from the second node, a first node capability information request, based on the first node capability information request, transmitting, to the second node, first node capability information, receiving, from the second node, semantic communication instruction information, by performing semantic communication learning based on the received semantic communication instruction information, performing training for at least one model, receiving, from the second node, target artificial intelligence (AI) task information, and by encoding input data based on a joint source channel coding (JSCC) encoder model corresponding to the target AI task information, transmitting, to the second node, the encoded input data, wherein the second node may have multiple AI tasks based on the semantic communication and may derive an output by providing reconstruction data generated based on a JSCC decoder model corresponding to the target AI task information as input to a configured target AI task among the multiple AI tasks.

In addition, according to an embodiment of the present disclosure, a first node in a wireless communication system, the first node may include: a transceiver, and a processor connected to the transceiver, wherein the processor is configured to perform operations may include: establishing a connection with a second node, controlling the transceiver to perform operations comprising receiving, from the second node, a first node capability information request, based on the first node capability information request, controlling the transceiver to perform operations comprising transmitting, to the second node, first node capability information, controlling the transceiver to perform operations comprising receiving, from the second node, semantic communication instruction information, by performing semantic communication learning based on the received semantic communication instruction information, performing training for at least one model, controlling the transceiver to perform operations comprising receiving, from the second node, target artificial intelligence (AI) task information, and by encoding input data based on a joint source channel coding (JSCC) encoder model corresponding to the target AI task information, controlling the transceiver to perform operations comprising transmitting, to the second node, the encoded input data, wherein the second node may have multiple AI tasks based on the semantic communication and may derive an output by providing reconstruction data generated based on a JSCC decoder model corresponding to the target AI task information as input to a configured target AI task among the multiple AI tasks.

In addition, according to an embodiment of the present disclosure, a method performed by a second node in a wireless communication system, the method may include: establishing a connection with a first node, transmitting, to a first node, a first node capability information request, based on the first node capability information request, receiving, from the second node, first node capability information, transmitting, to the first node, semantic communication instruction information;

by performing semantic communication learning, performing training for at least one model, transmitting, to the first node, target artificial intelligence (AI) task information, by receiving input data encoded based on a joint source channel coding (JSCC) encoder model corresponding to the target AI task information, generating reconstruction data, and by providing the reconstruction data as input to a configured target AI task among the multiple AI tasks, deriving an output, wherein the second node may have multiple AI tasks based on the semantic communication.

In addition, according to an embodiment of the present disclosure, a second node in a wireless communication system, the second node may include: a transceiver, and a processor connected to the transceiver, wherein the processor is configured to perform operations may include: establishing a connection with a first node, controlling the transceiver to perform operations comprising transmitting, to a first node, a first node capability information request, based on the first node capability information request, controlling the transceiver to perform operations comprising receiving, from the second node, first node capability information, controlling the transceiver to perform operations comprising transmitting, to the first node, semantic communication instruction information, by performing semantic communication learning, performing training for at least one model, controlling the transceiver to perform operations comprising transmitting, to the first node, target artificial intelligence (AI) task information, by receiving input data encoded based on a joint source channel coding (JSCC) encoder model corresponding to the target AI task information, generating reconstruction data, and by providing the reconstruction data as input to a configured target AI task among the multiple AI tasks, deriving an output, wherein the second node may have multiple AI tasks based on the semantic communication.

In addition, according to an embodiment of the present disclosure, a device, the device may include: at least one memory, and at least one processor operably connected to the at least one memory, wherein the at least one processor cause the device to perform operations may include: controlling the device to perform operations comprising establishing a connection with a another device, controlling the device to perform operations comprising receiving, from the another device, a first node capability information request, based on the first node capability information request, controlling the device to perform operations comprising transmitting, to the another device, first node capability information, controlling the device to perform operations comprising receiving, from the another device, semantic communication instruction information, by performing semantic communication learning based on the received semantic communication instruction information, controlling the device to perform operations comprising performing training for at least one model, controlling the device to perform operations comprising receiving, from the another device, target artificial intelligence (AI) task information, and by encoding input data based on a joint source channel coding (JSCC) encoder model corresponding to the target AI task information, controlling the device to perform operations comprising transmitting, to the another device, the encoded input data, wherein the another device may have multiple AI tasks based on the semantic communication and may derive an output by providing reconstruction data generated based on a JSCC decoder model corresponding to the target AI task information as input to a configured target AI task among the multiple AI tasks.

In addition, according to an embodiment of the present disclosure, a non-transitory computer-readable medium storing at least one instruction, the non-transitory computer-readable medium may include: the at least one instruction being executable by a processor, wherein the at least one instruction controls a device to perform operations may include: controlling the device to perform operations comprising establishing a connection with a another device, controlling the device to perform operations comprising receiving, from the another device, a first node capability information request, based on the first node capability information request, controlling the device to perform operations comprising transmitting, to the another device, first node capability information, controlling the device to perform operations comprising receiving, from the another device, semantic communication instruction information, by performing semantic communication learning based on the received semantic communication instruction information, controlling the device to perform operations comprising performing training for at least one model, controlling the device to perform operations comprising receiving, from the another device, target artificial intelligence (AI) task information, and by encoding input data based on a joint source channel coding (JSCC) encoder model corresponding to the target AI task information, controlling the device to perform operations comprising transmitting, to the another device, the encoded input data, wherein the another device may have multiple AI tasks based on the semantic communication and may derive an output by providing reconstruction data generated based on a JSCC decoder model corresponding to the target AI task information as input to a configured target AI task among the multiple AI tasks.

In addition, the following matters may commonly apply.

According to an embodiment of the present disclosure, the first node capability information may include information indicating whether the first node supports multiple AI tasks-based semantic communication. According to an embodiment of the present disclosure, the first node capability information may further include at least one of first node generation information, first node collection information, information related to types of processable raw data, or device computing capability information.

In addition, according to an embodiment of the present disclosure, when the second node determines to perform the multiple AI tasks-based semantic communication based on the first node capability information, the second node may transmit semantic communication instruction information to the first node. In addition, according to an embodiment of the present disclosure, semantic communication-related information may be transmitted to the first node along with the semantic communication instruction information.

In addition, according to an embodiment of the present disclosure, the semantic communication related information may include at least one of rate (R) information, a number (N) of supported AI tasks, an index table according to combinations of the AI tasks, joint source channel coding (JSCC) encoder and JSCC decoder model information, information related to whether a quantizer is used, mini batch size information, loss function information, or reconstruction distortion (D_{R}) information.

In addition, according to an embodiment of the present disclosure, based on the number (N) of supported AI tasks, a number of AI task combinations may be determined, and models corresponding to the number of AI task combinations, including JSCC encoder and JSCC decoder models and respective models of the supported AI tasks, may be configured. In addition, according to an embodiment of the present disclosure, when performing the semantic communication learning, training for the JSCC encoder and JSCC decoder models corresponding to the number of AI task combinations and training for the respective models of the supported AI tasks may be individually performed and thereafter, based on a joint scheme, the JSCC encoder and JSCC decoder models and the respective models of the supported AI tasks may be trained together.

In addition, according to an embodiment of the present disclosure, the target AI task information may be configured based on an index table corresponding to a number of AI task combinations. In addition, according to an embodiment of the present disclosure, when the target AI task information indicates a first index based on the index table, by selecting a first JSCC encoder model corresponding to the first index, the first node may configure the first JSCC encoder model. In addition, according to an embodiment of the present disclosure, by generating a semantic representation through encoding the input data based on the configured JSCC encoder model, the semantic representation may be transmitted to the second node.

In addition, according to an embodiment of the present disclosure, by selecting a first JSCC decoder model corresponding to the first index, the second node may configure the first JSCC decoder model. In addition, according to an embodiment of the present disclosure, by decoding the received semantic representation using the configured JSCC decoder model, the second node may obtain the reconstruction data.

In addition, according to an embodiment of the present disclosure, the reconstruction data may be provided as input to respective configured target AI tasks and an output may be derived based on a purpose of respective configured target AI tasks.

The above-described aspects of the present disclosure are only some of the preferred embodiments of the present disclosure, and various embodiments reflecting the technical features of the present disclosure may be derived and understood by those skilled in the art based on the following detailed description of the present disclosure.

According to embodiments based on the present disclosure, the following effects may be obtained.

According to the present disclosure, a method for performing semantic communication may be provided.

According to the present disclosure, an operation method based on multiple AI task operation performed based on semantic communication may be provided.

According to the present disclosure, learning may be performed based on combinations of AI tasks, which is performed based on semantic communication.

The present disclosure may perform multiple AI task-based communication based on a learning model corresponding to a configured target AI task, which is performed based on semantic communication in a wireless communication system.

Effects obtainable in embodiments of the present disclosure are not limited to the effects mentioned above, and other effects not mentioned may be clearly derived and understood by those skilled in the art to which the technical configuration of the present disclosure is applied from the following description of embodiments of the present disclosure. For example, even unintended effects resulting from implementing the configuration described in the present disclosure may be derived by those skilled in the art from the embodiments of the present disclosure.

### BRIEF DESCRIPTION OF THE DRAWINGS

The accompanying drawings are provided to help understanding of the present disclosure, and may provide embodiments of the present disclosure together with a detailed description. However, the technical features of the present disclosure are not limited to specific drawings, and the features disclosed in each drawing may be combined with each other to constitute a new embodiment. Reference numerals in each drawing may refer to structural elements.

FIG. 1 shows an example of a communication system applicable to the present disclosure.

FIG. 2 shows an example of a wireless device applicable to the present disclosure.

FIG. 3 shows a method of processing a transmitted signal applicable to the present disclosure.

FIG. 4 shows a communication procedure between a terminal and a base station applicable to the present disclosure.

FIG. 5 shows an example of a communication structure providable in a 6th generation (6G) system applicable to the present disclosure.

FIG. 6 shows an electromagnetic spectrum applicable to the present disclosure.

FIG. 7 shows a THz wireless communication transceiver applicable to the present disclosure.

FIG. 8 shows a THz signal generation method applicable to the present disclosure.

FIG. 9 shows a wireless communication transceiver applicable to the present disclosure.

FIG. 10 shows a transmitter structure applicable to the present disclosure.

FIG. 11 shows a modulator structure applicable to the present disclosure.

FIG. 12 shows a structure of a perceptron included in an artificial neural network applicable to the present disclosure.

FIG. 13 shows an artificial neural network structure applicable to the present disclosure.

FIG. 14 shows a communication model divided into three stages, applicable to the present disclosure.

FIG. 15 shows encoder and decoder blocks applicable to the present disclosure.

FIG. 16 shows an information bottleneck approach applicable to the present disclosure.

FIG. 17 shows a task-oriented semantic communication operation applying rate-distortion theory, applicable to the present disclosure.

FIG. 18 shows a method for performing multi-task-based semantic communication applicable to the present disclosure.

FIG. 19 shows a method for performing inference in semantic communication based on multi-task operation, applicable to the present disclosure.

FIG. 20 shows inference results in semantic communication based on multi-task operation, applicable to the present disclosure.

FIG. 21 shows an initial configuration method for semantic communication applicable to the present disclosure.

FIG. 22 shows information transmitted when learning for semantic communication based on multi-task operation is performed, applicable to the present disclosure.

FIG. 23 shows inference operation of multi-task-based semantic communication applicable to the present disclosure.

FIG. 24 shows a flowchart of a first node operation method applicable to the present disclosure.

FIG. 25 shows a flowchart of a second node operation method applicable to the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, the embodiment(s) of the present disclosure may be constructed by combining parts of the elements and/or features. Operation orders described in the embodiment(s) of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. In this case, the term “BS” may be replaced with a fixed station, a Node B, an eNB (eNode B), a gNB (gNode B), an ng-eNB, an advanced base station (ABS), an access point, etc.

In addition, in the embodiments of the present disclosure, the term terminal may be replaced with a user equipment (UE), a mobile station (MS), a subscriber station (SS), a mobile subscriber station (MSS), a mobile terminal, an advanced mobile station (AMS), etc.

In addition, a transmitter is a fixed and/or mobile node that provides a data service or a call service and a receiver is a fixed and/or mobile node that receives a data service or a call service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 38.211, 3GPP TS 38.212, 3GPP TS 38.213, 3GPP TS 38.321 and 3GPP TS 38.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

For example, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology after TS Release 17 and/or Release 18. “xxx” may refer to a detailed number of a standard document. LTE/NR/6G may be collectively referred to as a 3GPP system.

For background arts, terms, abbreviations, etc. used in the present disclosure, refer to matters described in the standard documents published prior to the present disclosure. For example, reference may be made to the standard documents 36.xxx and 38.XXX.

### Communication System Applicable to the Present Disclosure

Without being limited thereto, various descriptions, functions, procedures, proposals, methods and/or operational flowcharts of the present disclosure disclosed herein are applicable to various fields requiring wireless communication/connection (e.g., 5G).

Hereinafter, a more detailed description will be given with reference to the drawings. In the following drawings/description, the same reference numerals may exemplify the same or corresponding hardware blocks, software blocks or functional blocks unless indicated otherwise.

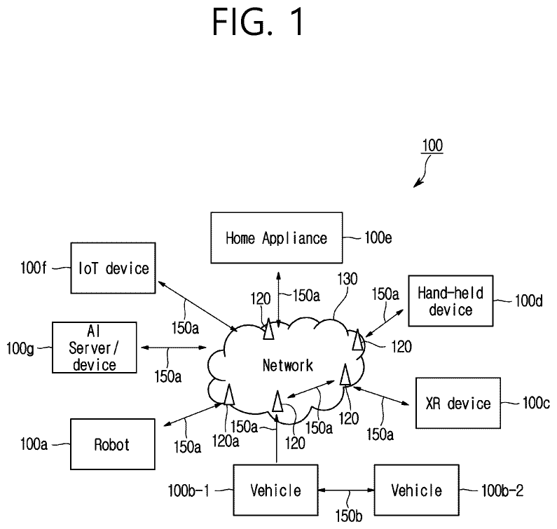

FIG. 1 shows an example of a communication system applicable to the present disclosure.

Referring to FIG. 1, the communication system 100 applicable to the present disclosure includes a wireless device, a base station and a network. The wireless device refers to a device for performing communication using radio access technology (e.g., LTE, LTE-A, LTE-A pro, NR or 5G, 5G-A, 6G) and may be referred to as a communication/wireless/5G device. Without being limited thereto, the wireless device may include a robot 100a, vehicles 100b-1 and 100b-2, an extended reality (XR) device 100c, a hand-held device 100d, a home appliance 100e, an Internet of Thing (IoT) device 100f, and an artificial intelligence (AI) device/server 100g. For example, the vehicles may include a vehicle having a wireless communication function, an autonomous vehicle, a vehicle capable of performing vehicle-to-vehicle communication, etc. The vehicles 100b-1 and 100b-2 may include an unmanned aerial vehicle (UAV) (e.g., a drone). The XR device 100c includes an augmented reality (AR)/virtual reality (VR)/mixed reality (MR) device and may be implemented in the form of a head-mounted device (HMD), a head-up display (HUD) provided in a vehicle, a television, a smartphone, a computer, a wearable device, a home appliance, a digital signage, a vehicle or a robot. The hand-held device 100d may include a smartphone, a smart pad, a wearable device (e.g., a smart watch or smart glasses), a computer (e.g., a laptop), etc. The home appliance 100e may include a TV, a refrigerator, a washing machine, etc. The IoT device 100f may include a sensor, a smart meter, etc. For example, the base station 120 and the network 130 may be implemented by a wireless device, and a specific wireless device 120a may operate as a base station/network node for another wireless device.

The wireless devices 100a to 100f may be connected to the network 130 through the base station 120. AI technology is applicable to the wireless devices 100a to 100f, and the wireless devices 100a to 100f may be connected to the AI server 100g through the network 130. The network 130 may be configured using a 3G network, a 4G (e.g., LTE) network, a 5G (e.g., NR) network or a 6G network, etc. The wireless devices 100a to 100f may communicate with each other through the base station 120/the network 130 or perform direct communication (e.g., sidelink communication) without through the base station 120/the network 130. For example, the vehicles 100b-1 and 100b-2 may perform direct communication (e.g., vehicle to vehicle (V2V)/vehicle to everything (V2X) communication). In addition, the IoT device 100f (e.g., a sensor) may perform direct communication with another IoT device (e.g., a sensor) or the other wireless devices 100a to 100f.

Wireless communications/connections 150a, 150b, 150c may be established between the wireless devices 100a to 100f/the base station 120 and the base station 120/the base station 120. Here, wireless communication/connection may be established through various radio access technologies such as uplink/downlink communication 150a, sidelink communication 150b (or D2D communication) or communication 150c between base stations (e.g., relay, integrated access backhaul (IAB). The wireless device and the base station/wireless device, the base station and the base station may transmit/receive radio signals to/from each other through wireless communication/connection 150a, 150b, 150c. For example, wireless communication/connection 150a, 150b, 150c may enable signal transmission/reception through various physical channels. To this end, based on the various proposals of the present disclosure, at least some of various configuration information configuration processes for transmission/reception of radio signals, various signal processing procedures (e.g., channel encoding/decoding, modulation/demodulation, resource mapping/demapping, etc.), resource allocation processes, etc. may be performed.

### Device Applicable to the Present Disclosure

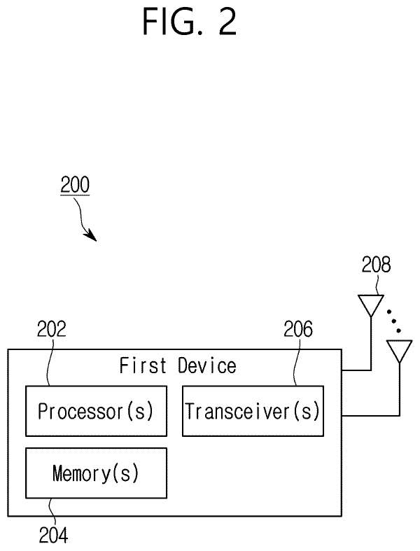

FIG. 2 shows an example of a wireless device applicable to the present disclosure.

Referring to FIG. 2, a wireless device 200 may transmit and receive radio signals through various radio access technologies (e.g., LTE, LTE-A, LTE-A pro, NR, 5G, 5G-A, 6G). The wireless device 200 includes at least one processor 202 and at least one memory 204, and may further include at least one transceiver 206 and/or at least one antenna 208.

The processor 202 may be configured to control the memory 204 and/or the transceiver 206 and to implement descriptions, functions, procedures, proposals, methods and/or operational flowcharts disclosed herein. For example, the processor 202 may process information in the memory 204 to generate first information/signal and then transmit a radio signal including the first information/signal through the transceiver 206. In addition, the processor 202 may receive a radio signal including second information/signal through the transceiver 206 and then store information obtained from signal processing of the second information/signal in the memory 204. The memory 204 may be coupled with the processor 202, and store a variety of information related to operation of the processor 202. For example, the memory 204 may store software code including instructions for performing all or some of the processes controlled by the processor 202 or performing the descriptions, functions, procedures, proposals, methods and/or operational flowcharts disclosed herein. Here, the processor 202 and the memory 204 may be part of a communication modem/circuit/chip designed to implement wireless communication technology. The transceiver 206 may be coupled with the processor 202 to transmit and/or receive radio signals through at least one antenna 208. The transceiver 206 may include a transmitter and/or a receiver. The transceiver 206 may be used interchangeably with a radio frequency (RF) unit. In the present disclosure, the wireless device may refer to a communication modem/circuit/chip.

Hereinafter, hardware elements of the wireless device 200 will be described in greater detail. Without being limited thereto, at least one protocol layer may be implemented by at least one processor 202. For example, at least one processor 202 may implement at least one layer (e.g., functional layers such as physical (PHY), media access control (MAC), radio link control (RLC), packet data convergence protocol (PDCP), radio resource control (RRC), service data adaptation protocol (SDAP)). At least one processor 202 may generate at least one protocol data unit (PDU) and/or at least one service data unit (SDU) according to the descriptions, functions, procedures, proposals, methods and/or operational flowcharts disclosed herein. At least one processor 202 may generate messages, control information, data or information according to the descriptions, functions, procedures, proposals, methods and/or operational flowcharts disclosed herein. At least one processor 202 may generate PDUs, SDUs, messages, control information, data or information according to the functions, procedures, proposals and/or methods disclosed herein and provide the PDUs, SDUs, messages, control information, data or information to at least one transceiver 206. At least One processor 202 may receive signals (e.g., baseband signals) from at least one transceiver 206 and obtain PDUs, SDUs, messages, control information, data or information according to the descriptions, functions, procedures, proposals, methods and/or operational flowcharts disclosed herein.

At least one processor 202 may be referred to as controllers, microcontrollers, microprocessors or microcomputers. At least one processor 202 may be implemented by hardware, firmware, software or a combination thereof. For example, at least one application specific integrated circuit (ASIC), at least one digital signal processor (DSP), at least one digital signal processing device (DSPD), at least one programmable logic device (PLD) or at least one field programmable gate array (FPGAs) may be included in at least one processor 202. The descriptions, functions, procedures, proposals, methods and/or operational flowcharts disclosed herein may be implemented using firmware or software, and firmware or software may be implemented to include modules, procedures, functions, etc. Firmware or software configured to perform the descriptions, functions, procedures, proposals, methods and/or operational flowcharts disclosed herein may be included in at least one processor 202 or stored in at least one memory 204 to be driven by at least one processor 202. The descriptions, functions, procedures, proposals, methods and/or operational flowcharts disclosed herein implemented using firmware or software in the form of code, a command and/or a set of commands.

At least one memory 204 may be coupled with at least one processor 202 to store various types of data, signals, messages, information, programs, code, instructions and/or commands. At least one memory 204 may be composed of read only memories (ROMs), random access memories (RAMs), erasable programmable read only memories (EPROMs), flash memories, hard drives, registers, cache memories, computer-readable storage mediums and/or combinations thereof. At least one memory 204 may be located inside and/or outside at least one processor 202. In addition, at least one memory 204 may be coupled with at least one processor 202 through various technologies such as wired or wireless connection.

At least one transceiver 206 may transmit user data, control information, radio signals/channels, etc. described in the methods and/or operational flowcharts of the present disclosure to at least one other device. At least one transceiver 206 may receive user data, control information, radio signals/channels, etc. described in the methods and/or operational flowcharts of the present disclosure from at least one other device. For example, at least one transceiver 206 may be coupled with at least one processor 202 to transmit/receive radio signals. For example, at least one processor 202 may perform control such that at least one transceiver 206 transmit user data, control information or radio signals to at least one other device. In addition, at least one processor 202 may perform control such that at least one transceiver 206 receive user data, control information or radio signals from at least one other device. In addition, at least one transceiver 206 may be coupled with at least one antenna 208, and at least one transceiver 206 may be configured to transmit/receive user data, control information, radio signals/channels, etc. described in the descriptions, functions, procedures, proposals, methods and/or operational flowcharts disclosed herein through at least one antenna 208. In the present disclosure, at least one antenna may be a plurality of physical antennas or a plurality of logical antennas (e.g., antenna ports). At least one transceiver 206 may convert the received radio signals/channels, etc. from RF band signals to baseband signals, in order to process the received user data, control information, radio signals/channels, etc. using at least one processor 202. At least one transceiver 206 may convert the user data, control information, radio signals/channels processed using at least one processor 202 from baseband signals into RF band signals. To this end, at least one transceiver 206 may include (analog) oscillator and/or filters.

Referring to FIG. 2, components of a wireless device described may be referred to by different terms in terms of functionality. For example, the processor 202 may be referred to as a controller, the transceiver 206 may be referred to as a communication unit, and the memory 204 may be referred to as a storage unit. In some cases, the communication unit may be used to mean including at least a part of the processor 202 and the transceiver 206.

Referring to FIG. 2, a structure of a wireless device described may be understood as at least a part of the structure of various devices. For example, the structure of the wireless device shown in FIG. 2 may be at least a part of the various devices described with reference to FIG. 1 (e.g., a robot 100a, vehicles 100b-1, 100b-2, an XR device 100c, a hand-held device 100d, a home appliance 100e, an IoT device 100f, an AI device/server 100g). Furthermore, based on various embodiments, in addition to the components shown in FIG. 2, the device may further include other components.

For example, the device may be a hand-held device such as a smartphone, a smart pad, a wearable device (e.g., a smart watch, smart glasses), or a hand-held computer (e.g., a laptop, etc.). In this case, the device may further include at least one of an input/output unit for inputting and outputting video information/signals, audio information/signals, data, and/or information input by a user, a power supply unit that supplies power and includes a wired/wireless charging circuit, a battery, etc., an interface unit including at least one port (e.g., an audio input/output port, a video input/output port) for connection with another device.

For example, the device may be a mobile device such as a mobile robot, a vehicle, a train, a manned/unmanned aerial vehicle (AV), a ship, etc. In this case, the device may further include at least one of a position measurement unit that obtains location information of the mobile device through a global positioning system (GPS), various sensors, a driving unit including at least one of an engine, a motor, a power train, wheels, brakes, a steering device of the device, a power supply unit that supplies power and includes a wired/wireless charging circuit, a battery, etc., a sensor unit that senses state information, environmental information, user information of or around the device, an autonomous driving unit that performs functions such as path maintenance, velocity control, destination configuration, etc.

For example, the device may be an XR device such as an HMD, a head-up display (HUD) provided in a vehicle, a television, a smartphone, a computer, a wearable device, a home appliance, a digital signage, a vehicle, a robot, etc. In this case, the device may further include at least one of a sensor unit that senses state information, environmental information, user information of or around the device, a power supply unit that supplies power and includes a wired/wireless charging circuit, a battery, etc., an input/output unit that obtains control information, data, etc., from outside and outputs generated XR objects.

For example, the device may be a robot that may be classified into industrial, medical, household, military, etc., use depending on the purpose or field of use. In this case, the device may further include at least one of a driving unit that performs various physical operations such as moving robot joints, a sensor unit that senses state information, environmental information, user information of or around the device.

For example, the device may be an AI device such as a TV, a projector, a smartphone, a PC, a laptop, a digital broadcast UE, a tablet PC, a wearable device, a set-top box (STB), a radio, a washing machine, a refrigerator, a digital signage, a robot, or a vehicle, or the like. In this case, the device may further include at least one of a training unit that trains a model configured with an artificial neural network by using training data, an input unit that obtains various types of data from outside, an output unit that generates outputs related to vision, hearing, touch, and the like, a sensor unit that senses state information, environmental information, or user information of or around the device.

The structure of the wireless device shown in FIG. 2 may be understood as a part of a RAN node (e.g., a base station, a DU, an RU, an RRH, etc.). For example, the device shown in FIG. 2 may be a RAN node. In this case, the device may further include a wired transceiver for front haul and/or back haul communication. However, if the front haul and/or back haul communication is based on wireless communication, at least one transceiver 206 shown in FIG. 2 may be used for the front haul and/or back haul communication, and a wired transceiver may not be included.

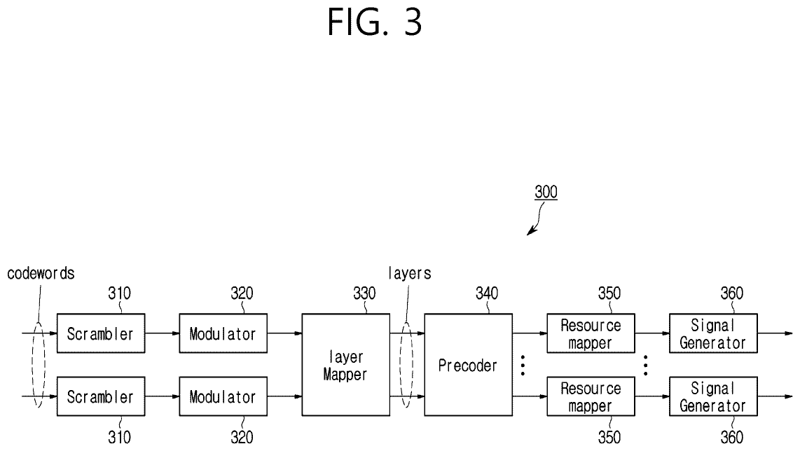

FIG. 3 shows a method of processing a transmitted signal applicable to the present disclosure. For example, the transmitted signal may be processed by a signal processing circuit. At this time, a signal processing circuit 300 may include a scrambler 310, a modulator 320, a layer mapper 330, a precoder 340, a resource mapper 350, a signal generator 360. At this time, for example, the operations/functions of FIG. 3 may be performed by the processor 202 and/or the transceiver 206 of FIG. 2. In addition, for example, the hardware element of FIG. 3 may be implemented in the processor 202 and/or the transceiver 206 of FIG. 2. For example, blocks 310 to 360 may be implemented in the processor 202 of FIG. 2. In addition, blocks 310 to 350 may be implemented in the processor 202 of FIG. 2, and block 360 may be implemented in the transceiver 206 of FIG. 2, without being limited to the above-described embodiments.

A codeword may be converted into a radio signal through the signal processing circuit 300 of FIG. 3. Here, the codeword is a coded bit sequence of an information block. The information block may include a transport block (e.g., a UL-SCH transport block, a DL-SCH transport block). The radio signal may be transmitted through various physical channels (e.g., a PUSCH, a PDSCH). Specifically, the codeword may be converted into a bit sequence scrambled by the scrambler 310. The scramble sequence used for scramble is generated based in an initial value and the initial value may include ID information of a wireless device, etc. The scrambled bit sequence may be modulated into a modulated symbol sequence by the modulator 320. The modulation method may include pi/2-binary phase shift keying (pi/2-BPSK), m-phase shift keying (m-PSK), m-quadrature amplitude modulation (m-QAM), etc.

A complex modulation symbol sequence may be mapped to at least one transport layer by the layer mapper 330. Modulation symbols of each transport layer may be mapped to corresponding antenna port(s) by the precoder 340. The output z of the precoder 340 may be obtained by multiplying the output y of the layer mapper 330 by a precoding matrix W of NXM. Here, N may be the number of antenna ports and M may be the number of transport layers. Here, the precoder 340 may perform precoding after transform precoding (e.g., discrete fourier transform (DFT)) for complex modulation symbols. In addition, the precoder 340 may perform precoding without performing transform precoding.

The resource mapper 350 may map modulation symbols of each antenna port to time-frequency resources. The time-frequency resources may include a plurality of symbols (e.g., a CP-OFDMA symbol, a DFT-s-OFDMA symbol) in the time domain and include a plurality of subcarriers in the frequency domain. The signal generator 360 may generate a radio signal from the mapped modulation symbols, and the generated radio signal may be transmitted to another device through each antenna. To this end, the signal generator 360 may include an inverse fast fourier transform (IFFT) module and a cyclic prefix (CP) insertor, a digital-to-analog converter (DAC), a frequency uplink converter, etc.

A signal processing procedure for a received signal in the wireless device may be configured as the inverse of the signal processing procedures 310 to 360 of FIG. 3. For example, the wireless device (e.g., 200 of FIG. 2) may receive a radio signal from the outside through an antenna port/transceiver. The received radio signal may be converted into a baseband signal through a signal restorer. To this end, the signal restorer may include a frequency downlink converter, an analog-to-digital converter (ADC), a CP remover, a fast fourier transform (FFT) module. Thereafter, the baseband signal may be restored to a codeword through a resource de-mapper process, a postcoding process, a demodulation process and a de-scrambling process. The codeword may be restored to an original information block through decoding. Accordingly, a signal processing circuit (not shown) for a received signal may include a signal restorer, a resource de-mapper, a postcoder, a demodulator, a de-scrambler and a decoder.

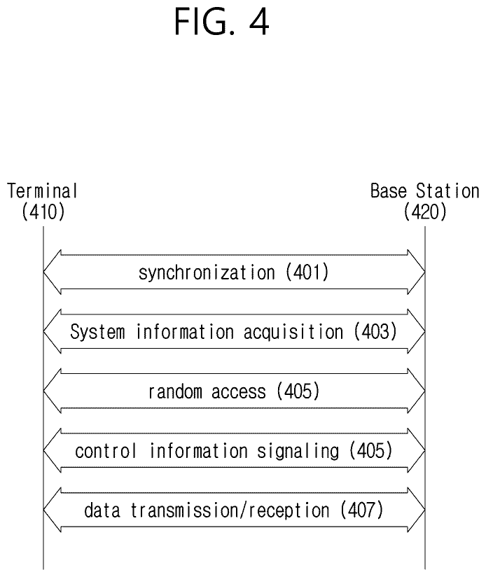

FIG. 4 shows a communication procedure between a terminal and a base station applicable to the present disclosure. FIG. 4 shows operations in which a terminal 410 and a base station 420 transmit and/or receive data, and operations performed prior thereto.

Referring to FIG. 4, in step 401, a terminal 410 and a base station 420 perform synchronization. For example, the terminal 410 performs an initial cell search operation. Specifically, the terminal 410 may detect at least one synchronization signal transmitted from the base station 420 based on a predefined rule. Here, the synchronization signal may include a plurality of synchronization signals classified based on structure or usage (e.g., a primary synchronization signal, a secondary synchronization signal). Through this, the terminal 410 may identify boundaries of a frame, a subframe, a slot, and/or a symbol of the base station 420, and may obtain information related to the base station 420 (e.g., a cell identifier).

In step 403, the terminal 410 obtains system information transmitted from the base station 420. The system information is information related to attributes, characteristics, and/or capabilities of the base station 420 necessary to access the base station 420 and use a service, and may be classified based on content (e.g., whether it is essential for access), transmission structure (e.g., which channel is used, whether it is provided on-demand). For example, the system information may be classified into a master information block (MIB) and a system information block (SIB). If necessary, the terminal 410 may transmit a signal requesting the system information before receiving the system information. However, the requesting and providing of the system information may be performed after random access procedure described later.

In step 405, the terminal 410 and the base station 420 perform random access procedure. The terminal 410 may transmit and/or receive at least one message (e.g., random access preamble, random access response (RAR) message, etc.) for random access procedure based on information related to random access channel of the base station 420 (e.g., channel location, channel structure, structure of supported preambles, etc.) obtained through system information. For example, the terminal 410 may transmit a preamble (e.g., MSG1) through random access channel, receive an RAR message (e.g., MSG2), transmit to the base station 420 a message (e.g., MSG3) including information related to the terminal 410 (e.g., identification information) by using scheduling information included in the RAR message, and receive a message (e.g., MSG4) for contention resolution and/or connection establishment. In another example, MSG1 and MSG3 may be transmitted and received as a single message, or MSG2 and MSG4 may be transmitted and received as a single message.

In step 407, the terminal 410 and the base station 420 perform signaling of control information. Here, the control information may be defined in various layers such as a layer controlling connections (e.g., a radio resource control (RRC) layer), a layer handling mapping between logical channels and transport channels (e.g., a media access control (MAC) layer), a layer that handles physical channels (e.g., a physical (PHY) layer). For example, the terminal 410 and the base station 420 may perform at least one of signaling for establishing a connection, signaling for determining configurations related to communication, signaling for indicating allocated resources.

In step 409, the terminal 410 and the base station 420 transmit and/or receive data. In other words, the terminal 410 and the base station 420 process and transmit and/or receive data based on signaling of control information. For example, when transmitting data, the terminal 410 or the base station 420 may perform at least one of channel encoding, rate matching, scrambling, constellation mapping, layer mapping, waveform modulation, antenna mapping, resource mapping on information bits. Conversely, when receiving data, the terminal 410 or the base station 420 may perform at least one of signal extraction from resources, waveform demodulation per antenna, signal placement considering layer mapping, constellation demapping, descrambling, channel decoding.

### 6G Communication System and Core Enabling Technologies of the 6G System

A 5G system defines various operating bands within frequency range 1 (FR1) including 410 MHz to 7125 MHz and frequency range 2 (FR2) including 24,250 MHz to 71,000 MHz. For subsequent 6G system operating bands, various frequencies are being discussed, and the use of higher frequencies than those of the 5G system is being considered for wider bandwidth and higher transmission rates. As one example, the use of the Terahertz (THz) frequency band including approximately 100 GHz to 10 THz is being discussed. The THz frequency band has both the permeability of radio waves and the straightness of light waves, and communication using the THz frequency band is also expected to serve as a transitional role from communication centered on radio waves to communication based on light waves.

In this way, a 6G system utilizing the THz frequency has purposes such as i) very high data rate per device, ii) a very large number of connected devices, iii) global connectivity, iv) very low latency, v) decrease in energy consumption of battery-free IoT devices, vi) ultra-reliable connectivity, vii) connected intelligence with machine learning capacity, etc. The vision of the 6G system may include four aspects such as “intelligent connectivity”, “deep connectivity”, “holographic connectivity”, “ubiquitous connectivity”, and the 6G system may be designed to satisfy the requirements shown in [Table 1] below.

TABLE 1

| | | |
|---|---|---|
| Per device peak data rate | 1 | Tbps |
| E2E latency | 1 | ms |
| Maximum spectral efficiency | 100 | bps/Hz |

| | |
|---|---|
| Mobility support | up to 1000 km/hr |
| Satellite integration | Fully |
| AI | Fully |
| Autonomous vehicle | Fully |
| XR | Fully |
| Haptic Communication | Fully |

At this time, the 6G system may have key factors such as enhanced mobile broadband (eMBB), ultra-reliable low latency communications (URLLC), massive machine type communications (mMTC), AI integrated communication, tactile Internet, high throughput, high network capacity, high energy efficiency, low backhaul and access network congestion and enhanced data security.

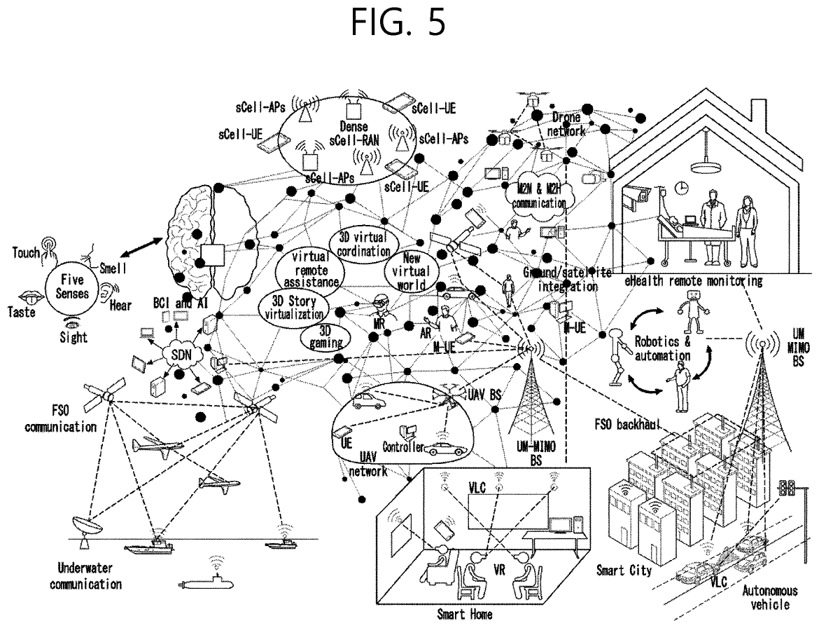

FIG. 5 shows an example of a communication structure providable in a 6G system applicable to the present disclosure. Referring to FIG. 5, the 6G system will have 50 times higher simultaneous wireless communication connectivity than a 5G wireless communication system. URLLC, which is the key feature of 5G, will become more important technology by providing end-to-end latency less than 1 ms in 6G communication. At this time, the 6G system may have much better volumetric spectrum efficiency unlike frequently used domain spectrum efficiency. The 6G system may provide advanced battery technology for energy harvesting and very long battery life and thus mobile devices may not need to be separately charged in the 6G system.

As core enabling technologies of the 6G system, technologies such as artificial intelligence (AI), Terahertz (THz) communication, optical wireless technology, FSO backhaul networks, large-scale MIMO technology, blockchain, 3D networking, quantum communication, unmanned aerial vehicles, cell-free communication, wireless information and energy transfer (WIET), integration of sensing and communication, integration of access and backhaul networks, holographic beamforming, big data analytics, large intelligent surfaces (LIS), etc. may be adopted.

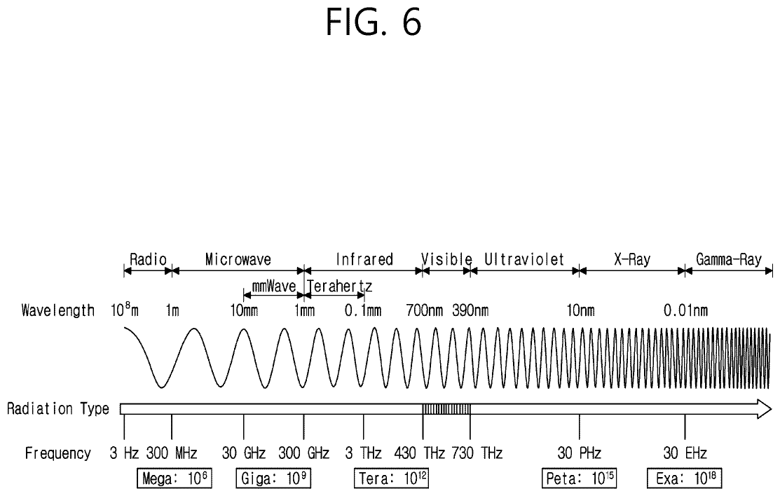

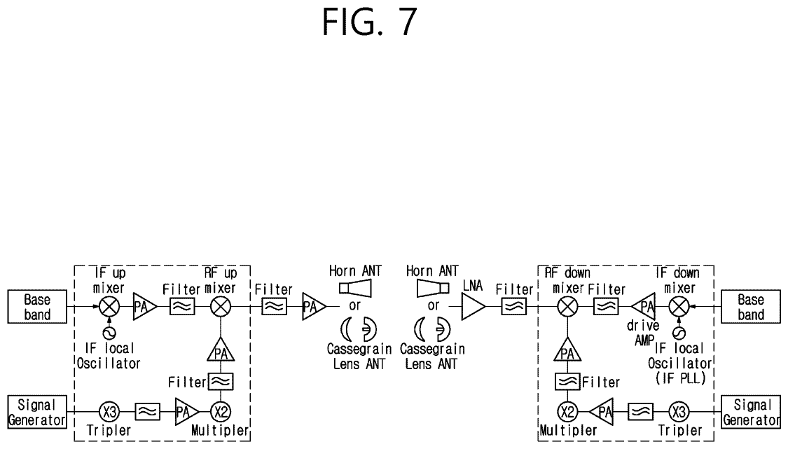

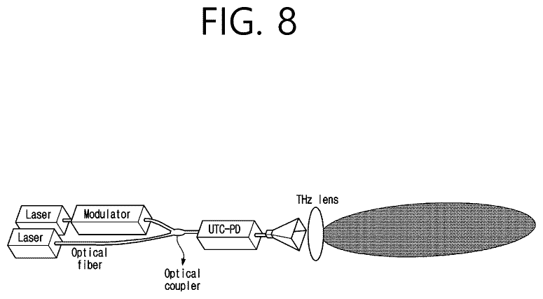

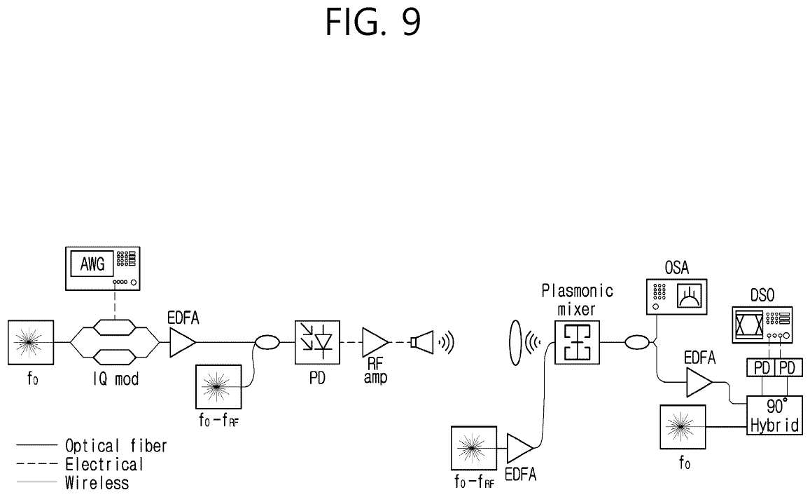

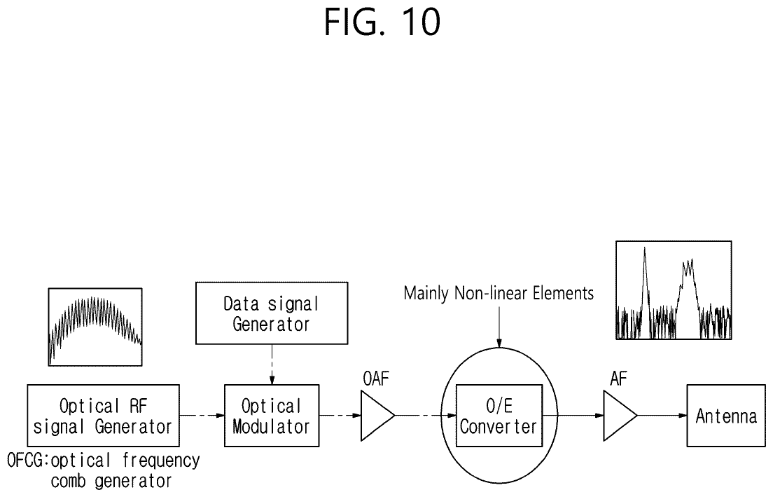

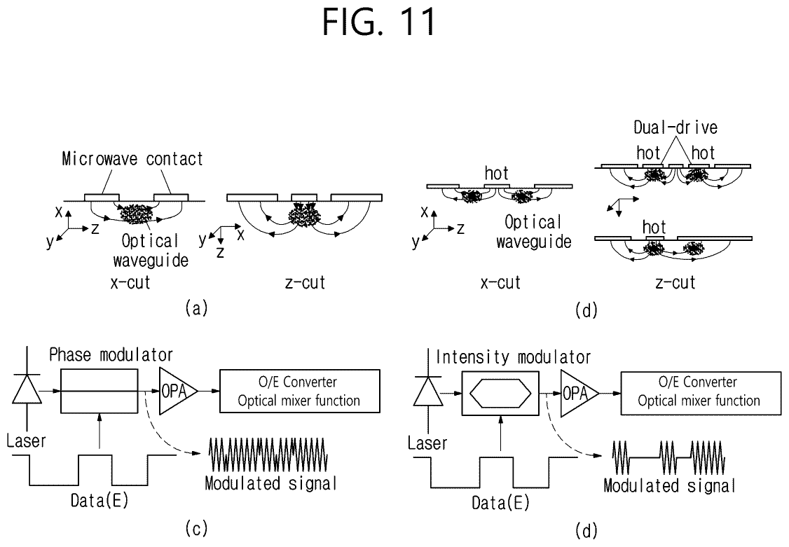

For example, THz communication refers to communication that uses a spectrum in a frequency band between 0.1 THz and 10 THz having wavelengths in the range of 0.03 mm to 3 mm, as shown in FIG. 6, and may be implemented by using circuit elements having structures such as those shown in FIG. 7. In addition, optical wireless technology is a technique for generating and modulating THz signals using optical devices and may be implemented based on devices having structures such as those shown in FIGS. 8, 9, 10, and 11.

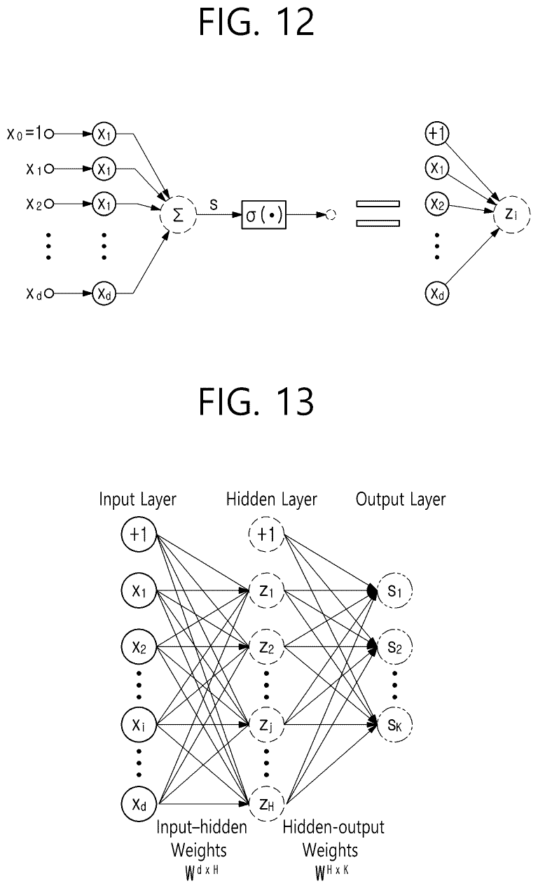

Artificial intelligence may also be implemented based on various models such as neural networks and machine-learning models. For example, a neural network-based AI model may be based on the structure of a perceptron as shown in FIG. 12. Referring to FIG. 12, an artificial neural network may be composed of multiple perceptrons. Depending on the structure of the perceptron, when an input vector x={x₁, x₂, . . . , x_d} is provided, each component is multiplied by corresponding weights {W₁, W₂, . . . , W_d}, and after summing the results, an activation function σ(·) is applied. When expanding the simplified perceptron structure shown in FIG. 12 into a large-scale artificial neural network, input vectors may be applied to perceptrons of different dimensionalities. When multiple perceptrons are stacked, a neural network having an input layer, a hidden layer, and an output layer, as illustrated in FIG. 13, may be configured.

### Detailed Embodiments of the Present Disclosure

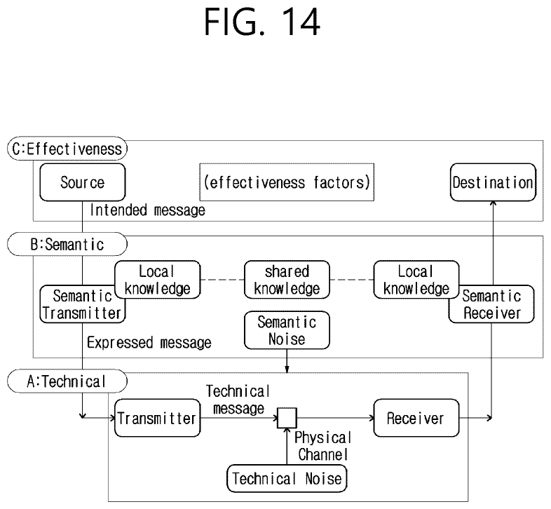

FIG. 14 shows a communication model divided into three stages, applicable to the present disclosure. Referring to FIG. 14, the communication model may be described in three stages. The first stage concerns whether symbols for communication are transmitted accurately in a technical sense, and Shannon's information theory can be regarded as an approach focused on this technical aspect. In contrast, the second stage concerns how accurately the transmitted symbols convey the correct meaning in a semantic aspect, and the third stage concerns how effectively the received meaning influences operations in the intended manner in an effectiveness aspect.

Among the various goals of 6G communication, one objective may be to provide services that interconnect humans and machines. As a next generation wireless communication paradigm for achieving this, semantic communication, which is based on the concept of “meaning delivery”, may be considered. For example, in conventional communication, a receiver (e.g., a destination) may decode an encoded signal received from a transmitter (e.g., a source) back into the original signal without error. In contrast, semantic communication may focus on the meaning that the signal intends to convey, similar to how people exchange information through the “meaning” of words during communication.

For example, in semantic communication, the communication criterion may be whether the concept related to a message sent by a source is correctly interpreted at a destination. For example, the source may generate a semantic representation based on raw data and transmit it to the destination. The destination may perform communication not for the purpose of reducing reconstruction error, but based on whether the task intended by the source is properly executed using the received semantic representation. For example, in semantic communication, the communication may be performed based on whether the task operation at the destination works correctly (e.g., whether the meaning has been correctly interpreted), rather than on reducing reconstruction error.

As a specific example, the source may generate a semantic representation and transmit it to the destination. Here, the source needs to generate the semantic representation in consideration of the task operation performed at the destination. For example, the source may operate based on a task-oriented semantic communication system that enables the source to generate a semantic representation such that the task operation at the destination is properly performed. In this regard, it may be necessary to introduce invariance useful for the task performed at the destination while preserving task-relevant information. For semantic communication considering the above, a new layer called a semantic layer may be added to manage the overall operation of semantic representations and messages. The semantic layer may be located at both the source and the destination in accordance with the task-oriented semantic communication system. To enable communication between semantic layers located at the source and the destination, a protocol and a series of operational procedures between the layers may need to be defined.

For example, a rate-distortion approach (or perspective) may be considered in relation to semantic communication; however, this is only an example and is not limited thereto. When lossy compression is performed based on a rate-distortion approach, the compression ratio and the loss may have a trade off relationship. For example, signal loss may refer to the degree of distortion between the original data and the reconstructed data generated after decoding. For example, signal loss may be based on the difference between the restored information and the original information.

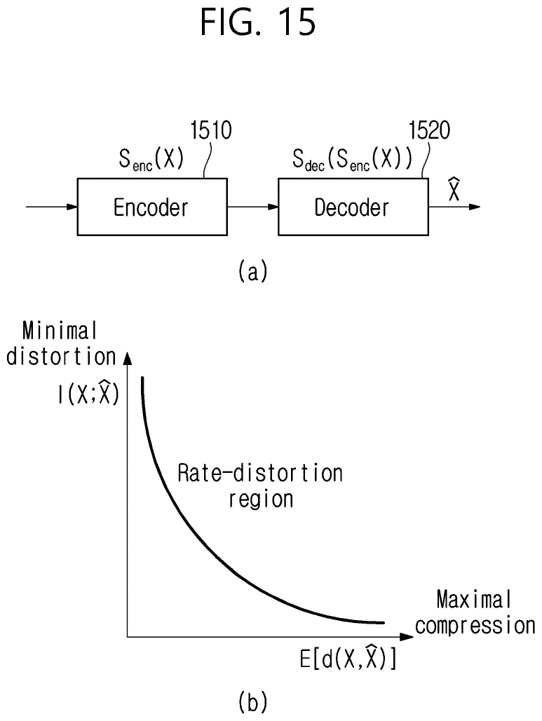

FIG. 15 shows encoder and decoder blocks applicable to the present disclosure. Referring to FIG. 15(a), an input X is processed by an encoder 1510, and received information is decoded by a decoder 1520 to generate a reconstructed output \hat{X}. Here, distortion D between the input X and the output \hat{X} may be given by Equation 1 below. If a maximum allowable distortion D* between X and \hat{X} is permitted, a transmission rate R may be given by Equation 2 below, and the trade off relationship between transmission rate and distortion may be expressed as a rate-distortion curve as shown in FIG. 15(b). Here, the achievable region may be determined as the region above the rate-distortion curve.

$$D = {\sum }_{X , \hat{X}} p ( X ) p ( \hat{X} \vert X ) d ( X , \hat{X} ) where d ( X , \hat{X} ) \\ is the distortion metric \qquad [ Equation 1 ]$$

$$R ( {D}^{*} ) = {min}_{p ( \hat{X} \vert X )} I ( X ; \hat{X} ) s . t . D \leq {D}^{*} \qquad [ Equation 2 ]$$

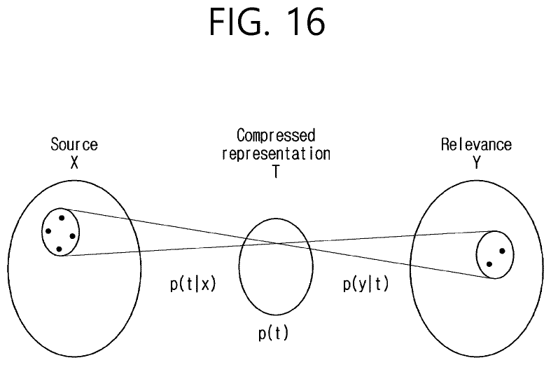

FIG. 16 shows an information bottleneck approach applicable to the present disclosure. Referring to FIG. 16, the rate-distortion approach may be extended to an information bottleneck (IB) approach, which addresses the problem of compressing a source through encoding and decoding while preserving relevant variables of the source. When the joint probability distribution p(X, Y) between a random variable X and an observed relevant variable Y is given, the IB approach may operate to compress X while preserving information related to Y. Accordingly, Y may implicitly define which parts of X are relevant and which are not, and when a compressed representation T is given, the above problem may be expressed as Equation 3.

$${min}_{p ( t \vert x )} I ( X ; T ) - β I ( T , Y ) \qquad [ Equation 3 ]$$

In Equation 3, I(X; T) and I(T; Y) may represent mutual information (MI), which is an index indicating how dependent one random variable is on another, with respect to X and T and with respect to T and Y, respectively. The IB approach may aim to minimize I(X; T), maximize I(T; Y), and maximize the compression ratio while finding an optimal trade off between preserved effectiveness information.

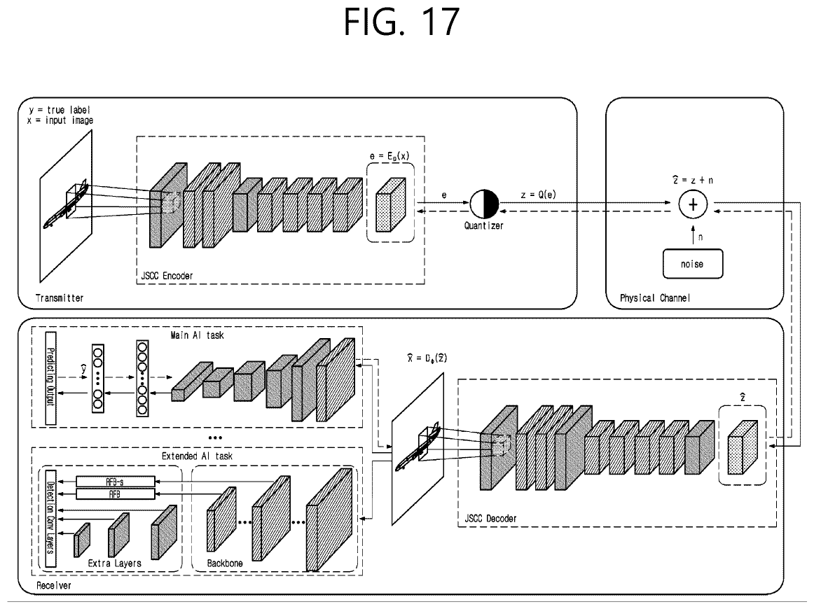

FIG. 17 shows a task-oriented semantic communication operation applying rate-distortion theory, applicable to the present disclosure. Referring to FIG. 17, an input is derived into a semantic representation by an encoder, and the semantic representation may be restored into reconstructed data by a decoder. The reconstructed data may then be used as input to an artificial intelligence (AI) task. For example, the semantic communication shown in FIG. 17 may be a task-oriented semantic communication method in which data is reconstructed by decoding signals encoded based on rate-distortion theory and transmitted through a channel, and the reconstructed data is used as input to a downstream task to obtain the output intended by the source.

As a specific example, referring to FIG. 17, learning for a joint source channel coding (JSCC) encoder and a JSCC decoder may be performed to obtain reconstructed data \hat{X} from input data X. Here, the JSCC encoder and JSCC decoder may be jointly trained based on the reconstructed data. In addition, separate learning may be performed for downstream tasks serving as the main AI tasks. For example, an AI task may also be added in a pre-trained form, and the present disclosure is not limited to any specific type.

For example, separate learning may be performed for the JSCC encoder and JSCC decoder and for the AI tasks. Thereafter, the two modules may be trained together in a joint manner. A loss function used to train the two modules simultaneously may be as shown in Equation 4. In Equation 4, R may be the rate given in Equation 2, and λ may be a hyperparameter representing the trade off between rate and distortion. In addition, D_{R} may be Mean Squared Error (MSE) reconstruction distortion and may be expressed as Equation 5. Furthermore, in Equation 4, D_{T} may be task-related distortion and may be expressed as Equation 6. Here, D_{T}(X, \hat{X}) may represent the expected value of related-information distortion between X and \hat{X}, and Y may be the true label held by the main AI task for learning. Finally, in Equation 4, β may be a hyperparameter representing the trade off between reconstruction quality and the target downstream task.

$$ℒ = R + λ ( {D}_{R} ( X , \hat{X} ) + β {D}_{T} ( X , \hat{X} ) ) \qquad [ Equation 4 ]$$

$${D}_{R} ( X , \hat{X} ) = {𝔼}_{p ( x , \hat{x} )} [ {d}_{R} ( x , \hat{x} ) ] , where {d}_{R} ( x , \hat{x} ) = {‖ x - \hat{x} ‖}^{2} \qquad [ Equation 5 ]$$

$${D}_{T} ( X , \hat{X} ) = I ( X ; Y ) - I ( \hat{X} ; Y ) \qquad [ Equation 6 ]$$

In addition, after all learning is performed as described in FIG. 17, an extended AI task may be additionally included in an add-on manner, in which a downstream task having a purpose different from existing tasks is added, to evaluate generalization performance. Here, after reconstructing the input data, learning may be performed based on a single task at the destination. For example, when considering multi-task having different purposes at the destination, some tasks may not be considered during learning. In view of the above, an operation method that considers multi-task in semantic communication may be required, and a method for this is described below.

Below, methods and procedures for operating in consideration of multi-task operation at the destination in a system that supports semantic communication are described. For example, the operations described below may correspond to the semantic level operation of Level B in FIG. 14 and may be applied when bidirectional communication is performed. However, for convenience of explanation, the following description is based on a unidirectional communication scenario, although the same may apply to bidirectional communication.

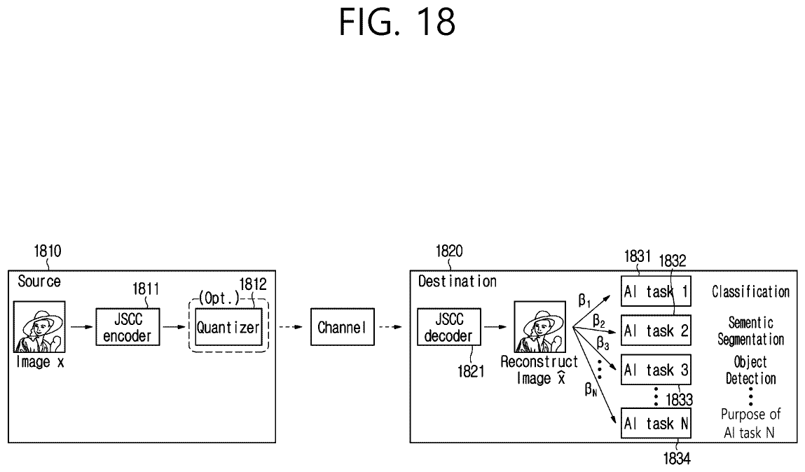

FIG. 18 shows a method for performing multi-task-based semantic communication applicable to the present disclosure. Referring to FIG. 18, a source 1810 and a destination 1820 may each possess a labeled dataset required for training AI tasks. For example, the source 1810 may be an entity that transmits data, such as a UE, a base station, or another device. Likewise, the destination 1820 may be an entity that receives data and performs AI tasks suited to its purpose, such as a UE, a base station, or another device. For example, the source 1810 and the destination 1820 may each be communication entities, and are not limited to any particular type of device. For convenience of explanation, the description below is based on the source 1810 and the destination 1820.

For example, the source 1810 and the destination 1820 may each possess a labeled dataset required for training AI tasks, and the destination 1820 may perform multiple AI tasks 1831, 1832, 1833, 1834. Each AI task 1831, 1832, 1833, 1834 may operate according to a different purpose. For example, as described above, data transmitted from the source and reconstructed may be provided as input to each of the AI tasks 1831, 1832, 1833, 1834, and each of the AI tasks may operate according to its own purpose based on the input. For example, AI Task 1 1811 in FIG. 18 may perform classification, while the other AI tasks may perform operations for different purposes, such as semantic segmentation or object detection, rather than performing different classifications. For example, the destination 1820 may perform multi-task operations, and each task may operate with a different purpose.

As a specific example, the source 1810 may encode input data X through a JSCC encoder 1811 and transmit a resulting latent vector to the destination 1820 through a wireless channel. Here, the latent vector may represent a semantic representation. For convenience of explanation, the following description is based on the semantic representation. However, it is not limited to this wording and may alternatively be referred to as a latent vector or another term, and the present disclosure is not limited to a particular embodiment.

For example, in FIG. 18, the data x may be an image; however, this is merely one example for convenience of explanation and is not limited thereto. In another example, the semantic representation derived from the data x may pass through a quantizer 1812 and then be transmitted to the destination 1820 through a wireless channel, although this is not limiting. The destination 1820 may decode the received semantic representation through a JSCC decoder 1821 and obtain reconstructed data \hat{X}. The destination 1820 may then use \hat{X} as input to each AI task 1831, 1832, 1833, 1834 and may check the output after performing the downstream task operations corresponding to each purpose. Here, the JSCC encoder 1811, the JSCC decoder 1821, and the AI tasks 1831, 1832, 1833, 1834 that constitute the source 1810 and the destination 1820 may each form a neural network model based on data modality. For example, the neural network may be a deep neural network (DNN) model, although it is not limited thereto. Here, when the destination 1820 supports N AI tasks, the combinations of AI task operations at the destination may amount to 2^{N}−1. For example, depending on whether each AI task operates, all combinations may be considered from a single AI task operating to all AI tasks operating simultaneously. Accordingly, the JSCC encoder 1811 and the JSCC decoder 1821 may each have 2^{N}−1 models at the source and destination, respectively. As N increases, the number of possible combinations increases exponentially, and thus the number of models may also increase. However, each model may be reduced in size using a model compression technique. For example, at least one of quantization, pruning, and distillation may be applied during training to reduce model size. Nonetheless, this is merely one example and is not limiting. The source 1810 and the destination 1820 may each apply the above-described model compression techniques to their respective DNN models and may thus maintain multiple models.

As described above, neural network models for the JSCC encoder 1810 and JSCC decoder 1820 may be provided corresponding to the possible combinations of AI tasks. Here, learning may first be performed for the DNN models corresponding to the JSCC encoder 1810 and the JSCC decoder 1820 and for the DNN models corresponding to the AI tasks 1831, 1832, 1833, 1834 held by the destination 1820. For example, learning for the DNN models corresponding to the JSCC encoder 1810 and JSCC decoder 1820 and learning for the AI tasks may be performed separately.

Thereafter, joint learning may be performed simultaneously for the DNN models corresponding to the JSCC encoder 1810, the JSCC decoder 1820, and the AI tasks 1831, 1832, 1833, 1834. The loss function used for such learning may be as shown in Equation 7, and Equation 7 may consider task-relevant distortion for all tasks held by the destination.

As a specific example, in Equation 7, R may be the rate given as in Equation 2, and k may represent the k-th combination among the 2^{N}−1 combinations in which AI tasks at the destination may operate. In addition, Lₖ may be the loss function of the k-th combination, and λₖ may be a hyperparameter used to control the distortion required for the k-th combination in relation to the rate-distortion tradeoff. Further, D_{R}may represent reconstruction distortion between the input data X and the reconstructed data \hat{X}. For example, various methods used for data reconstruction may be applied to define reconstruction distortion, and the present disclosure is not limited to any specific type. For example, MSE reconstruction distortion related to pixel level error, as described in Equation 5, may be used, although this is not limiting. In addition, N may be the number of AI tasks supported at the destination 1820.

$${ℒ}_{k} = R + {λ}_{k} ( {D}_{R} ( X , \hat{X} ) + {\sum }_{i = 1}^{N} {β}_{k , i} * ( I ( X ; {Y}_{i} ) - I ( \hat{X} ; {Y}_{i} ) ) ) , \\ where k = 1 , … {2}^{N} - 1 \qquad [ Equation 7 ]$$

For example, in Equation 7, the parameters R, D_{R}, and N may be configured through the configuration of the source 1810 and the destination 1820. Here, Yᵢ may be the true label held by the i-th AI task. For example, learning may be performed by adjusting distortion based on comparing the mutual information corresponding to input data X and Y and the reconstructed data \hat{X}. Here, β_{(k,i)} may be a hyperparameter for the i-th AI task in the k-th combination. For example, when the i-th AI task is not included in the k-th combination, β_{(k,i)} may be configured to 0. For example, β_{(k,i)} may reflect whether the AI task used in the k-th combination is included.

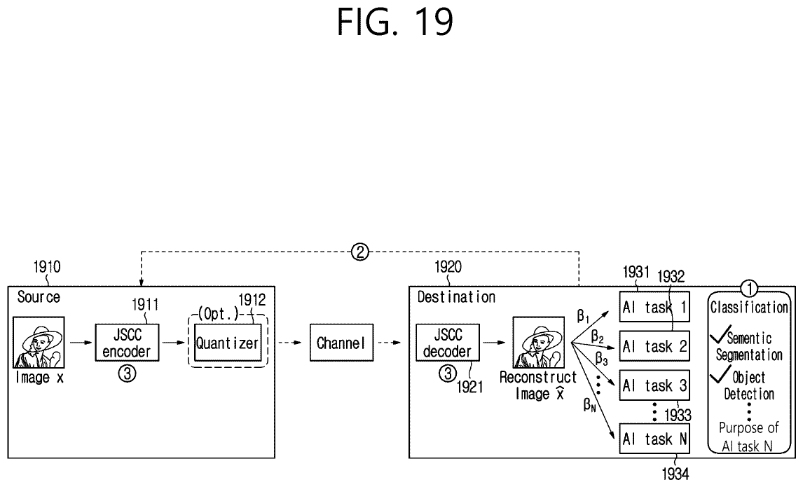

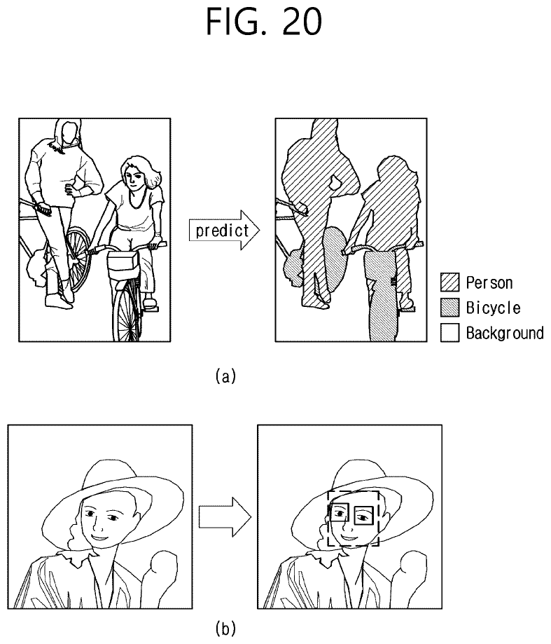

Based on the learning performed as described above, inference may be performed using the constructed model. FIG. 19 shows a method for performing inference in semantic communication based on multi-task operation, applicable to the present disclosure. Referring to FIG. 19, after learning related to multi-task support has been performed in semantic communication, inference may be performed. For example, the destination 1920 may determine a target AI task and transmit instruction information for the target AI task to the source 1910. For example, the destination 1920 may select an AI task among the N AI tasks that can provide the desired output, and the possible combinations may be 2^{N}−1, as described above.

As a specific example, in FIG. 19, the input data may be an image, and configurations may be applied to obtain results for semantic segmentation and object detection. Here, an AI task for performing the corresponding operation may be selected. After selecting an AI task, the destination 1920 may transmit the selected AI task information to the source 1910. For example, the destination 1920 may transmit index information corresponding to a selected combination of AI tasks among the N AI tasks to the source 1810. In Equation 7, k may correspond to the index. Here, Table 2 below may be an index table according to the target AI task combinations between the source 1910 and the destination 1920 when N=3. The destination 1920 may transmit to the source 1910 the index based on Table 2. The source 1910 may identify at least one AI task corresponding to the received index to determine what operation the destination 1920 intends to perform. However, this is merely one example, and N may be configured differently.

TABLE 2

| Index | Types of operating AI tasks |
|---|---|
| 0 | AI task 1 |
| 1 | AI task 2 |
| 2 | AI task 3 |
| 3 | AI task 1, AI task 2 |
| 4 | AI task 1, AI task 3 |
| 5 | AI task 2, AI task 3 |
| 6 | AI task 1, AI task 2, AI task 3 |

Thereafter, the source 1910 and the destination 1920 may configure a JSCC encoder 1911 and a JSCC decoder 1921. Specifically, the source 1910 and the destination 1920 may select JSCC encoder and JSCC decoder models corresponding to one of the 2^{N}−1 combinations based on AI task-related information. The source 1910 may then encode input data through the JSCC encoder 1911 to generate a semantic representation and transmit it to the destination 1920. The destination 1920 may decode the received semantic representation through the JSCC decoder 1921 to obtain reconstructed data. The reconstructed data may then be provided to the configured AI tasks to perform task-based operations. As a specific example, in FIG. 19, semantic segmentation and object detection may be performed as AI tasks, and outputs such as those illustrated in FIG. 20 may be obtained accordingly.

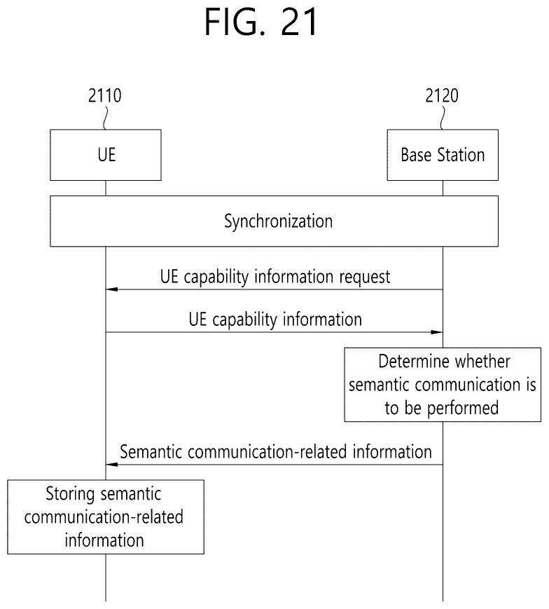

FIG. 21 shows an initial configuration method for semantic communication applicable to the present disclosure. Referring to FIG. 21, a UE 2110 may obtain a synchronization signal from a base station 2120, perform synchronization, and establish a connection. For example, in FIG. 21, the source described above may correspond to the UE 2110 and the destination may correspond to the base station 2120. However, this is merely an example for convenience of explanation, and the source may be the base station 2120 and the destination may be the UE 2110, and the same applies to bidirectional communication as well. The present disclosure is not limited to any specific configuration.

Thereafter, the base station 2120 may request UE capability information from the UE 2110. Here, the UE capability information may include various types of information depending on the UE type. For example, the UE capability information may include information indicating whether the UE supports the above-described semantic communication capability. For example, the UE capability information may include semantic communication capability information of the UE. The UE 2110 may transmit the UE capability information to the base station 2120 based on the request. For example, the UE capability information may further include information on the types of raw data that the UE can generate, collect, or process, and information on the device's computing capability, although it is not limited thereto. Thereafter, the base station 2120 may determine whether semantic communication is to be performed. For example, the base station 2120 may recognize, based on the UE capability information, that the UE 2110 supports semantic communication. The base station 2120 may further consider other obtained information and parameters to determine whether semantic communication is to be performed and may instruct the UE accordingly. For example, when the base station 2120 decides to perform communication with the UE 2110 based on semantic communication, the base station 2120 may transmit information instructing semantic communication to the UE 2110. This semantic communication instruction information may include semantic communication-related information. The UE 2110 may store the semantic communication-related information transmitted along with the instruction. For example, semantic communication-related information may include at least one of the number N of supported AI tasks, an index table corresponding to AI task combinations, rate R, JSCC encoder/decoder models, information indicating whether a quantizer is used, mini-batch size information, loss function information, and reconstruction distortion D_{R}. For example, semantic communication-related information may include information required for configuring training in consideration of the above-described multi-task operation, and the present disclosure is not limited thereto.

In another example, the semantic communication instruction information and the semantic communication-related information may be transmitted from the base station 2120 to the UE 2110 through at least one of downlink control information (DCI), a medium access control (MAC) control element (CE), and a radio resource control (RRC) message.

In another example, semantic communication instruction information may be indicated through higher layer signaling, and semantic communication-related information may be transmitted through DCI.

For example, the base station 2120 may obtain UE capability information from the UE 2110 and, when semantic communication is possible in the manner described above, may transmit semantic communication-related information to the UE 2110. The UE 2110 may store the received information and may perform the above-described semantic communication.

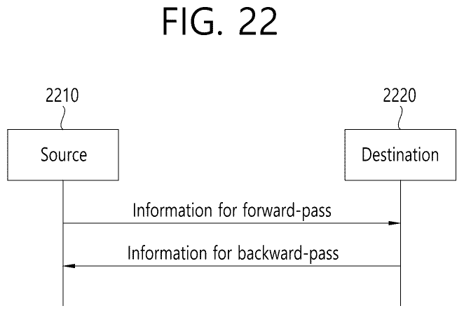

FIG. 22 shows information transmitted when learning for semantic communication based on multi-task operation is performed, applicable to the present disclosure.

For example, in FIG. 22, the source may be the UE 2210 and the destination may be the base station 2220. However, this is merely one example for convenience of explanation, and the same may apply when the source is the base station 2220 and the destination is the UE 2210. The same also applies when bidirectional communication is performed, and the present disclosure is not limited thereto. Referring to FIG. 22, learning may be performed 2^{N}−1 times in consideration of combinations of AI multi-task operations. Here, when learning is performed, information may be transmitted in each mini-batch. For example, information for the forward-pass transmitted from the source 2210 to the destination 2220 may include results of the JSCC encoder operation. In addition, when a quantizer is included as described above, the result reflecting the quantization operation may also be included as forward-pass information and transmitted to the destination 2220. Thereafter, the destination 2220 may also transmit information for the backward-pass to the source 2210. For example, the information for the backward-pass may include gradient information used for learning. As described above, when learning is performed at both the source 2210 and the destination 2220, corresponding information may be exchanged, and this operation may be performed 2^{N}−1 times per mini-batch in consideration of AI multi-task combinations.

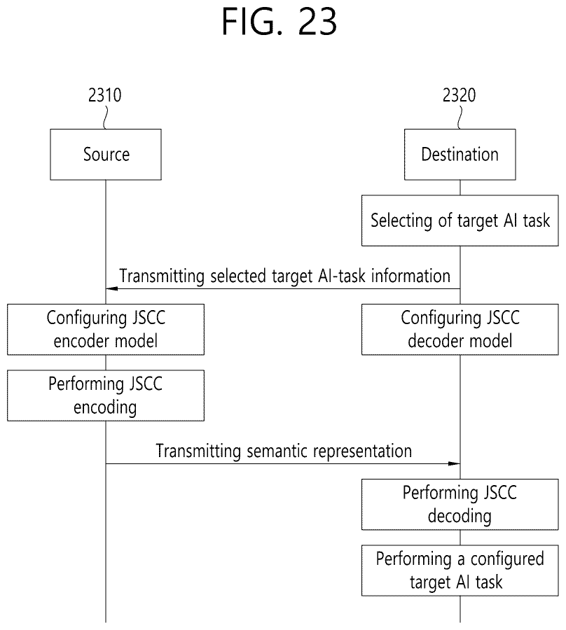

FIG. 23 shows inference operation of multi-task-based semantic communication applicable to the present disclosure.

For example, in FIG. 23, the source may be the UE 2310 and the destination may be the base station 2320. However, this is merely an example for convenience of explanation, and the same may apply when the source is the base station 2320 and the destination is the UE 2310. The same also applies when bidirectional communication is performed, and the present disclosure is not limited thereto. Referring to FIG. 23, the destination 2320 may select a target AI task. The destination 2320 may select the target AI task appropriate for the intended output. After that, the destination 2320 may transmit the selected target AI task information to the source 2310. Here, the possible combinations of AI tasks may be 2^{N}−1, and index information corresponding to the possible combinations may be transmitted from the destination 2320 to the source 2310. For example, the index information corresponding to the combinations may be as shown in Table 2 described above, although this is not limiting.

Thereafter, the source 2310 and the destination 2320 may each configure JSCC encoder and JSCC decoder models corresponding to the index. When input data is given, the source 2310 may encode the input data through the JSCC encoder to generate a semantic representation. For example, when a quantizer is applied as described above, a quantization operation may be performed and a semantic representation may be generated, although this is not limiting. The source 2310 may then transmit the semantic representation to the destination 2320. The destination 2320 may decode the received semantic representation through the JSCC decoder and may provide the reconstructed data obtained through decoding as input to each configured AI task. Thereafter, each configured AI task may be executed and an output operation may be derived. Based on the above, learning and inference may be performed in a system that supports semantic communication when multi-task operation is performed at the destination.

For example, learning may be performed for each model by configuring an index table based on a loss function that considers multi-task operation and combinations of AI tasks. After learning is completed, instruction information corresponding to the target AI task operation configured at the destination may be transmitted, and inference operations corresponding to the instruction may then be performed at both the source and the destination. Through this, the destination may obtain the intended output according to each AI task operation.

In FIGS. 21 to 23 described above, the source is described as the UE and the destination as the base station; however, the present disclosure is not limited thereto, as described above. For example, the operations in FIGS. 21 to 23 may be performed in consideration of the characteristics of the source and the destination. As a specific example, when the source is the UE and the destination is the base station as described above, the UE may obtain control information through RRC signaling or DCI, whereas when both the source and the destination are UEs, control information may be obtained through PC5-RRC signaling or sidelink control information (SCI). For example, the operations of the source and the destination may be performed as described above, but signaling or operations suitable for the characteristics of the source and the destination may also be combined, and the present disclosure is not limited to a particular embodiment.

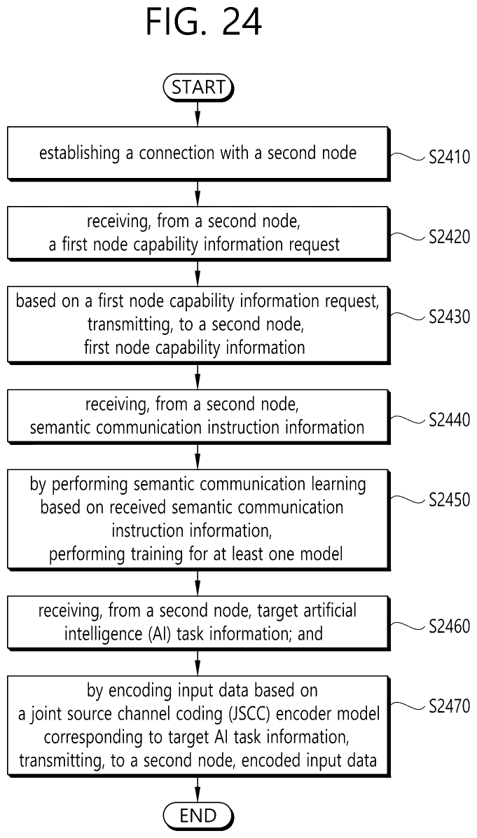

FIG. 24 shows a flowchart of a first node operation method applicable to the present disclosure.

Referring to FIG. 24, the first node may establish a connection with the second node (S2410). Here, the first node may be the source and the second node may be the destination. In another example, the first node may be the destination and the second node may be the source, and the present disclosure is not limited thereto. After establishing a connection with the second node, the first node may receive a first node capability information request from the second node (S2420). The first node may transmit first node capability information to the second node based on the capability information request (S2430). The first node capability information may include information indicating whether the first node supports semantic communication based on multiple AI tasks. In another example, the first node capability information may further include at least one of information generated by the first node, information collected by the first node, information related to types of raw data processable by the device, and computing capability information of the device.

Here, the first node may correspond to the source described above, and the second node may correspond to the destination. In one example, the first node may be a UE and the second node may be a base station. In another example, the first node may be a base station and the second node may be a UE. In another example, both the first node and the second node may be UEs, referring to respective devices in device-to-device communication. In another example, the first node and the second node may each be a device performing communication as the source or destination as described above, and the present disclosure is not limited to any specific form.

Thereafter, the second node may determine whether semantic communication is to be performed based on the received first node capability information and may transmit semantic communication instruction information to the first node (S2440). The second node may also transmit semantic communication-related information together with the instruction information. The semantic communication-related information may include at least one of rate R information, the number N of supported AI tasks, an index table according to AI task combinations, JSCC encoder and JSCC decoder model information, information indicating whether a quantizer is used, mini-batch size information, loss function information, and reconstruction distortion D_{R}. The first node may then perform learning for semantic communication based on the received information and may perform learning for at least one model (S2450). Here, the number of AI task combinations may be determined based on the number N of supported AI tasks. The number of JSCC encoder and JSCC decoder models may correspond to the number of AI task combinations. In addition, a model for each AI task may be configured. When learning is performed based on semantic communication, learning for the JSCC encoder and JSCC decoder models corresponding to the AI task combinations may be performed. In addition, learning for respective models of the supported AI tasks may be individually performed. Thereafter, the JSCC encoder and JSCC decoder models and the models for the AI tasks may be jointly trained, as represented by Equation 7 described above.

Based on the above, learning for each model based on multiple AI tasks may be completed. Thereafter, inference may be performed based on the learned models. Here, the second node may determine a target AI task that meets the output purpose among the multiple AI tasks and may transmit the corresponding information to the first node (S2460). The first node may encode input data through a corresponding JSCC encoder model based on the received target AI task information. Here, for example, the target AI task information may be configured based on an index table corresponding to the number of AI task combinations. As a specific example, when the target AI task information indicates a first index based on the index table, the first node may select a first JSCC encoder model corresponding to the first index, configure the JSCC encoder model, and encode input data to transmit it to the second node. For example, the first node may generate a semantic representation through JSCC encoding of the input data based on the configured JSCC encoder model and transmit the semantic representation to the second node, as described above (S2470). Thereafter, the second node may select a first JSCC decoder model corresponding to the first index and configure the JSCC decoder model. The second node may decode the received semantic representation through the configured JSCC decoder model to obtain reconstructed data. The reconstructed data may be provided as input to each configured target AI task, and an output may be derived based on the purpose of each configured target AI task.

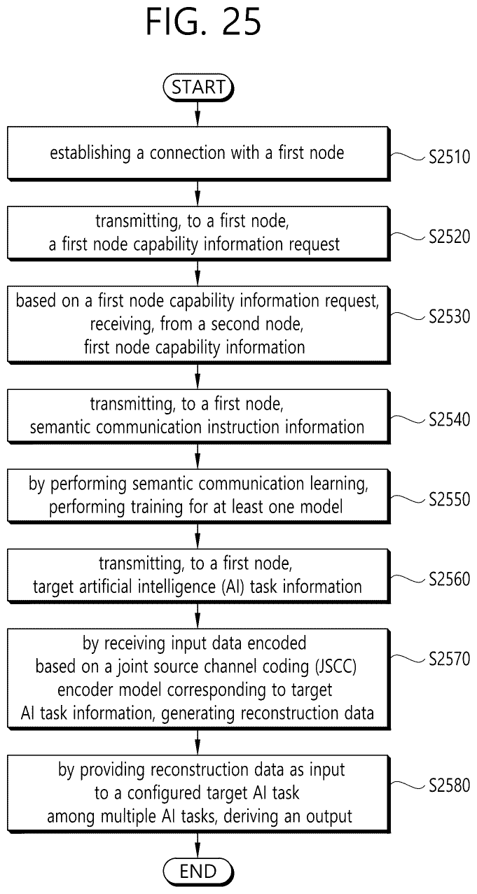

FIG. 25 shows a flowchart of a second node operation method applicable to the present disclosure. Referring to FIG. 25, the second node may establish a connection with the first node (S2510). Here, the first node may be the source and the second node may be the destination. In another example, the first node may be the destination and the second node may be the source, and the present disclosure is not limited thereto. After the first node establishes a connection with the second node, the second node may transmit a first node capability information request to the first node (S2520). The first node may transmit first node capability information to the second node based on the request, and the second node may receive the information (S2530). The first node capability information may include information indicating whether the first node supports semantic communication based on multiple AI tasks. In another example, the first node capability information may further include at least one of information generated by the first node, information collected by the first node, information related to types of raw data processable, and device computing capability information.

Here, the first node may correspond to the source described above, and the second node may correspond to the destination. In one example, the first node may be a UE and the second node may be a base station. In another example, the first node may be a base station and the second node may be a UE. In another example, both the first and second nodes may be UEs, referring to respective devices in device-to-device communication. In another example, the first and second nodes may be any other devices performing communication as the source and the destination as described above, and the present disclosure is not limited to a specific form.

Thereafter, the second node may determine whether semantic communication is to be performed based on the received first node capability information and may transmit semantic communication instruction information to the first node (S2540). The second node may also transmit semantic communication-related information together with the instruction information. The semantic communication-related information may include at least one of rate R information, the number N of supported AI tasks, an index table according to AI task combinations, JSCC encoder and JSCC decoder model information, information indicating whether a quantizer is used, mini-batch size information, loss function information, and reconstruction distortion D_{R}. The second node may then perform learning for semantic communication based on the information delivered to the first node and may perform learning for at least one model (S2550). Here, the number of AI task combinations may be determined based on the number N of supported AI tasks. The number of JSCC encoder and JSCC decoder models may correspond to the number of AI task combinations. In addition, a model for each AI task may be configured. When learning is performed based on semantic communication, learning for JSCC encoder and JSCC decoder models corresponding to the combinations of AI tasks may be performed. In addition, learning for respective models of the supported AI tasks may be performed individually. Thereafter, the JSCC encoder and JSCC decoder models and the respective models of the AI tasks may be trained together in a joint manner, as represented by Equation 7 described above.

Based on the above, learning for each model based on multiple AI tasks may be completed. Thereafter, inference may be performed based on the learned models. Here, the second node may determine a target AI task that matches the output purpose among the multiple AI tasks and may transmit the corresponding information to the first node (S2560). The first node may encode input data through a corresponding JSCC encoder model based on the received target AI task information. For example, the target AI task information may be configured based on an index table corresponding to the number of AI task combinations. As a specific example, when the target AI task information indicates a first index based on the index table, the first node may select a first JSCC encoder model corresponding to the first index, configure the JSCC encoder model, and encode the input data to transmit it to the second node. The first node may generate a semantic representation through JSCC encoding based on the configured JSCC encoder model and transmit the semantic representation to the second node, as described above (S2470). The second node may then select a first JSCC decoder model corresponding to the first index, configure the JSCC decoder model, and decode the received semantic representation through the configured decoder model to obtain reconstructed data (S2570). The second node may provide the reconstructed data as input to each configured target AI task and may derive outputs based on the purpose of each configured target AI task, as described above (S2580).

It is evident that the examples of the proposed methods described above may also be included as implementation methods of the present disclosure and may be regarded as types of proposed methods. In addition, examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method, the method comprising:
establishing, by a first node, a connection with a second node;
receiving, by the first node from the second node, a first node capability information request;
based on the first node capability information request, transmitting, by the first node to the second node, first node capability information;
receiving, by the first node from the second node, semantic communication instruction information;
by performing semantic communication learning based on the received semantic communication instruction information, performing, by the first node, training for at least one model;
receiving, by the first node from the second node, target artificial intelligence (AI) task information; and
by encoding input data based on a joint source channel coding (JSCC) encoder model related to the target AI task information, transmitting, by the first node to the second node, the encoded input data,
wherein the second node has multiple AI tasks based on the semantic communication and derives an output by providing reconstruction data generated based on a JSCC decoder model related to the target AI task information as input to a configured target AI task among the multiple AI tasks.

2. The method of claim 1,
wherein the first node capability information includes information indicating whether the first node supports multiple AI tasks-based semantic communication, and
wherein the first node capability information further includes at least one of first node generation information, first node collection information, information related to types of processable raw data, or device computing capability information.

3. The method of claim 2,
wherein, when the second node determines to perform the multiple AI tasks-based semantic communication based on the first node capability information, the second node transmits semantic communication instruction information to the first node, and
wherein semantic communication-related information is transmitted to the first node along with the semantic communication instruction information.

4. The method of claim 3,
wherein the semantic communication related information includes at least one of rate (R) information, a number (N) of supported AI tasks, an index table according to combinations of the AI tasks, joint source channel coding (JSCC) encoder and JSCC decoder model information, information related to whether a quantizer is used, mini batch size information, loss function information, or reconstruction distortion (D_{R}) information.

5. The method of claim 4,
wherein, based on the number (N) of supported AI tasks, a number of AI task combinations is determined, and models related to the number of AI task combinations, including JSCC encoder and JSCC decoder models and respective models of the supported AI tasks, are configured, and
wherein, when performing the semantic communication learning, training for the JSCC encoder and JSCC decoder models related to the number of AI task combinations and training for the respective models of the supported AI tasks are individually performed and thereafter, based on a joint scheme, the JSCC encoder and JSCC decoder models and the respective models of the supported AI tasks are trained together.

6. The method of claim 1,
wherein the target AI task information is configured based on an index table related to a number of AI task combinations,
wherein, when the target AI task information indicates a first index based on the index table, by selecting a first JSCC encoder model related to the first index, the first node configures the first JSCC encoder model, and
wherein, by generating a semantic representation through encoding the input data based on the configured JSCC encoder model, the semantic representation is transmitted to the second node.

7. The method of claim 6,
wherein, by selecting a first JSCC decoder model related to the first index, the second node configures the first JSCC decoder model, and
wherein, by decoding the received semantic representation using the configured JSCC decoder model, the second node obtains the reconstruction data.

8. The method of claim 7,
wherein the reconstruction data is provided as input to respective configured target AI tasks and an output is derived based on a purpose of respective configured target AI tasks.

9. A first node comprising:
a transceiver; and
a processor connected to the transceiver,
wherein the processor is configured to perform operations comprising:
establishing a connection with a second node;
controlling the transceiver to perform operations comprising receiving, from the second node, a first node capability information request;
based on the first node capability information request, controlling the transceiver to perform operations comprising transmitting, to the second node, first node capability information;
controlling the transceiver to perform operations comprising receiving, from the second node, semantic communication instruction information;
by performing semantic communication learning based on the received semantic communication instruction information, performing training for at least one model;
controlling the transceiver to perform operations comprising receiving, from the second node, target artificial intelligence (AI) task information; and
by encoding input data based on a joint source channel coding (JSCC) encoder model related to the target AI task information, controlling the transceiver to perform operations comprising transmitting, to the second node, the encoded input data,
wherein the second node has multiple AI tasks based on the semantic communication and derives an output by providing reconstruction data generated based on a JSCC decoder model related to the target AI task information as input to a configured target AI task among the multiple AI tasks.

10. A method comprising:
establishing, by a second node, a connection with a first node;
transmitting, by the second node to a first node, a first node capability information request;
based on the first node capability information request, receiving, by the second node from the second node, first node capability information;
transmitting, by the second node to the first node, semantic communication instruction information;
by performing semantic communication learning, performing, by the second node, training for at least one model;
transmitting, by the second node to the first node, target artificial intelligence (AI) task information;
by receiving input data encoded based on a joint source channel coding (JSCC) encoder model related to the target AI task information, generating, by the second node, reconstruction data; and
by providing the reconstruction data as input to a configured target AI task among the multiple AI tasks, deriving, by the second node, an output,
wherein the second node has multiple AI tasks based on the semantic communication.

11. The method of claim 10,
wherein the first node capability information includes information indicating whether the first node supports multiple AI tasks-based semantic communication, and
wherein the first node capability information further includes at least one of first node generation information, first node collection information, information related to types of processable raw data, or device computing capability information.

12. The method of claim 11,
wherein, when the second node determines to perform the multiple AI tasks-based semantic communication based on the first node capability information, the second node transmits semantic communication instruction information to the first node, and
wherein semantic communication-related information is transmitted to the first node along with the semantic communication instruction information.

13. The method of claim 12,
wherein the semantic communication related information includes at least one of rate (R) information, a number (N) of supported AI tasks, an index table according to combinations of the AI tasks, joint source channel coding (JSCC) encoder and JSCC decoder model information, information related to whether a quantizer is used, mini batch size information, loss function information, or reconstruction distortion (D_{R}) information.

14. The method of claim 13,
wherein, based on the number (N) of supported AI tasks, a number of AI task combinations is determined, and models related to the number of AI task combinations, including JSCC encoder and JSCC decoder models and respective models of the supported AI tasks, are configured, and
wherein, when performing the semantic communication learning, training for the JSCC encoder and JSCC decoder models related to the number of AI task combinations and training for the respective models of the supported AI tasks are individually performed and thereafter, based on a joint scheme, the JSCC encoder and JSCC decoder models and the respective models of the supported AI tasks are trained together.

15. The method of claim 10,
wherein the target AI task information is configured based on an index table related to a number of AI task combinations,
wherein, when the target AI task information indicates a first index based on the index table, the first node, by selecting a first JSCC encoder model related to the first index, configures the first JSCC encoder model, and
wherein, by generating a semantic representation through encoding the input data based on the configured JSCC encoder model, transmitting, to the second node, the semantic representation.

16. The method of claim 15,
wherein, by selecting a first JSCC decoder model related to the first index, the second node configures the first JSCC decoder model, and
wherein, by decoding the received semantic representation using the configured JSCC decoder model, the second node obtains the reconstruction data.

17. The method of claim 16,
wherein the reconstruction data is provided as input to respective configured target AI tasks and an output is derived based on a purpose of respective configured target AI tasks.

18.-20. (canceled)

21. The first node of claim 9,
wherein the information related to the subcarriers includes at least one of a frequency spacing of the subcarriers allocated for the radar operation or a time spacing of the at least one OFDM symbol.

22. The first node of claim 21,
wherein the subcarriers allocated for the radar operation are configured in a frequency-comb type including subcarriers spaced in designated OFDM symbols.

23. The first node of claim 22,
wherein the semantic communication related information includes at least one of rate (R) information, a number (N) of supported AI tasks, an index table according to combinations of the AI tasks, joint source channel coding (JSCC) encoder and JSCC decoder model information, information related to whether a quantizer is used, mini batch size information, loss function information, or reconstruction distortion (D_{R}) information.
